(19) United States
(12) Patent Application Publication
(10) Pub. No.: US 2019/0047177 A1
(43) Pub. Date: Feb. 14, 2019

(54) Method of manufacturing a fishing lure

(71) Applicant: Noah Bradley Daves, Chesapeake, VA (US)

(72) Inventor: Noah Bradley Daves, Chesapeake, VA (US)

(21) Appl. No.: 15/732,585

(22) Filed: Nov. 29, 2017

Related U.S. Application Data
(60) Provisional application No. 62/543,005, filed on Aug. 9, 2017.

(51) Int. Cl. B28D 1/14; A01K 85/12; B23P 19/04

(52) U.S. Cl. CPC B28D 1/14; B23P 19/04; A01K 85/12

(57) ABSTRACT

A fishing lure is manufactured by boring a hole through a granite stone body. A straight brass tube that is initially longer than the stone body is initially held in place inside of the hole, such that the axis of the hole and the axis of the brass tube are congruent, by a pair of rubber stoppers located at opposite ends of the hole. Before the second stopper is put into place, a curable liquid adhesive is poured into the annular space between the brass tube and the stone body. The second stopper is then secured to the brass tube at the opposite end of the stone body and he adhesive is allowed to cure. The protruding opposite ends of the brass tube are secured to a lathe, and the outside of the stone body is turned down on the lathe to the desired shape. After the lure body has been shaped and polished, one or both of the protruding ends of the brass tube is shortened to its finished length.

### CROSS-REFERENCE TO RELATED APPLICATION

This application claims the benefit of prior provisional patent application Ser. No. 62/543,005, filed Aug. 9, 2017.

### BACKGROUND OF THE INVENTION

### 1. Field of the Invention

The present invention relates to methods for manufacturing fishing lures. More particularly the present invention relates to methods for manufacturing a fishing lure in which the body of the lure is formed from a natural stone such as granite.

### 2. Description of the Prior Art

A fishing lure is an artificial object that, in use, is typically attached onto the end of a fishing line and used to attract fish. Lures that are made, either entirely or predominantly, of natural stones are known in the prior art. Lures that are constructed from natural stones are known to be extremely durable and environmentally safe, as well as having other attributes that are useful.

U.S. Pat. No. 5,715,627 to Jones discloses natural rock fishing lure. The Jones lure is manufactured by percussion, wherein hammer-like blows against the exposed surface of the natural rock result in random fracturing. Rings, which facilitate attachment of a fishing line and a hook, are attached to the body of Jones lure using a clamping mechanism. The Jones lure cannot be readily manufactured, using the disclosed process, to have a smooth hydrodynamic exterior shape of uniform cross-section, nor to have a through-hole along the longitudinal axis of the lure body that is adapted to receive a fishing line.

U.S. Pat. No. 6,076,297 to Lippincott discloses a natural weight manufactured from stone, concrete or other material. A central hole is bored through the body of the weight and the hole is filled with a protruding elastomeric member that has nodules at each end to hold the elastomeric member to the body of the lure. The elastomeric member is provided with “loops” or other means for direct attachment of a fishing line to the elastomeric member. A problem with the device thusly constructed is that it is not adapted to receive a fishing line that continuously passes through the center of the body of the device.

U.S. Pat. No. 9,015,985 to Pauley et al discloses a fishing sinker comprising a tumbled limestone body and a break-away fastener element. A problem with the device thusly constructed is that it is not adapted to receive a fishing line that continuously passes through the center of the body of the device.

U.S. Pat. No. 8,266,838 to Parkinson discloses a method of manufacturing a fly-fishing lure. The Parkinson manufacturing method does not produce a lure having a lure body comprising a natural stone, nor does it produce a lure having a central longitudinal opening that is adapted to receive a continuous fishing line.

U.S. Pat. No. 3,982,350 to Heckathorn discloses a device that is adapted to attach a stone or rock to a fishing line to function as a casting or sinker weight. The Heckathorn method of assembling a stone or rock to a fishing line essentially comprises wrapping a flexible strap around the stone or rock, but it does not result in a fishing lure having a central longitudinal opening that is adapted to receive a continuous fishing line that passes through the body of the device

U.S. Pat. No. 5,490,345 to Infinger discloses a fishing lure having a convexly tapered weight member having a narrow leading portion, a broad trailing portion and an axial opening that extends through the weight from the leading portion to the trailing portion. An elongate conduit extends axially through the central shaft and into the axial opening of the weight for slidably receiving a fishing line. The Infinger device is constructed by introducing a tubular conduit a short distance into the opening through the trailing portion and a fast-drying waterproof adhesive is deposited on the exterior surface of the conduit proximate the entrance to the opening, and, according to Infinger, drawing the adhesive into the opening where it quickly dries to secure the tubular conduit in place. A problem with this prior method of constructing a fishing lure is that because the uncured adhesive is first deposited on the exterior of the tubular conduit before it is drawn into the axial shaft, either (1) the adhesive will likely be scraped off of the tubular conduit due to the shaft's diameter being too small, or (2) the axis of the conduit will not be congruent with the axis of the shaft due to there being too much “play” between the outside surface of the conduit and the wall of the shaft.

U.S. Patent Application Publication 2012/0102817 to Klaput discloses an environmentally friendly granite fishing lure. The Klaput reference discloses a lure having a granite stone body. According to the Klaput reference, a slot or groove is formed along a major axis of the body of the lure using a diamond saw or similar tool or, in other embodiments, a drill or similar tool may be used to drill an axial hole through the body of the lure. A chafe-resistant tubing, made from nylon or similar material, is disposed inside of the groove or axial hole. The Klaput reference discloses that cement is used to affix the tubing (inside the hole) to the granite body, but the Klaput reference does not disclose how this manufacturing step would be accomplished. In any event, if the chafe tubing of the Klaput device were to be cemented to the lure body in accordance with known prior methods, for example such as disclosed in the above-mentioned Infinger reference, either (1) the adhesive will likely be scraped off of the tubular conduit due to the shaft's diameter being too small, or (2) the axis of the conduit will not be congruent with the axis of the shaft due to there being too much “play” between the outside surface of the conduit and the wall of the shaft.

There is, then, a need for a method of constructing a fishing lure that overcomes the above described problems in the prior art.

### OBJECTS AND SUMMARY OF THE INVENTION

In light of the foregoing background, the present invention provides a fishing lure having a granite stone body that is adapted to be removably installed on a fishing line, and a method for manufacturing same.

It is an object of the present invention to provide a method of manufacturing a fishing lure in which a straight brass tube can be precisely and accurately positioned and adhered inside of a through hole in the lure body, such that the longitudinal axes of the brass tube and through hole are congruent with each other.

It is another object of the present invention to provide a method of manufacturing a fishing lure of the character described wherein a liquid adhesive can readily be poured into the annular space between the brass tube and the stone body of the lure during the manufacturing process.

It is another object of the present invention to provide a method of manufacturing a fishing lure of the character described wherein at least a portion of the brass tube protrudes to the exterior of the stone body of the lure, so as to provide a convenient method of holding the subassembly (including the unfinished stone body) in place on a lathe while the surface of the lure body is being shaped during the manufacturing process.

It is another object of the present invention to provide a method of manufacturing a fishing lure of the character described in which a filler material having a density different from that of the stone body of the lure is incorporated into the lure body in order to advantageously affect the manner in which the lure “swims” through water when in use.

It is another object to provide a modification of the present invention to produce a fishing lure of the character described in which the lure body comprises multiple stone members are arranged in longitudinal order and adhered to each other.

It is another object to provide a modification of the present invention to produce a fishing lure of the character described in which the lure body comprises a pair of similar stone members adjoined to each other on opposite sides of the longitudinal axis of the body of the lure.

It is another object to provide a modification of the present invention wherein multiple lure bodies can be cut in a single lathe operation from one piece of stone.

Other objects, features and advantages of the present invention will become readily apparent from the following detailed description of the preferred embodiment when considered with the attached drawings and the appended claims.

### DESCRIPTION OF THE DRAWINGS

FIG. 1 is a side elevation of a fishing lure manufactured in accordance with the method of the present invention;

FIG. 2 is a front elevation of a fishing lure manufactured in accordance with the method of the present invention;

FIG. 3 is a medial cross-section view of a fishing lure taken along the line 3-3 of FIG. 1;

FIG. 4 is a transverse cross-section view of a fishing lure taken along the line 4-4 of FIG. 1;

FIG. 5 is a side view of fishing lure having an attached skirt member, manufacture in accordance with the method of the present invention;

FIG. 6 is a schematic flow diagram showing the preferred steps in manufacturing a fishing lure according to the present invention;

FIG. 7 is a medial cross-section elevation view of a granite stock material bored with a hole according to a step in the manufacture of a fishing lure in accordance with the present invention;

FIG. 8 is a medial cross-section elevation view of a granite stock material with a brass tube stock material and a single press-fit stopper according to a step in the manufacture of a fishing lure in accordance with the present invention;

FIG. 9 is a perspective view of a stopper member used in the manufacture process of the present invention;

FIG. 10 is a medial cross-section elevation view similar to FIG. 8, but showing adhesive poured inside of the annular opening between the brass tube and the granite material according to a step in the manufacture of a fishing lure in accordance with the present invention;

FIG. 11 is a medial cross-section elevation view similar to FIG. 9, but showing a second stopper member inserted into the bored hole according to a step in the manufacture of a fishing lure in accordance with the present invention; and,

FIG. 12 is a medial cross-section elevation view of a modified embodiment of the present invention, showing a counter-bored lure body with filler material.

### REFERENCE NUMERALS IN DRAWINGS

A Longitudinal Axis
A1 Longitudinal Axis, granite stock
10 Lure body
12 Brass tube
13 Brass tubing stock
13a 1^{st} end, brass tubing stock
13b 2^{nd} end, brass tubing stock
14 Chafing tube
15 Skirt
16 Shoulder
17 1^{st} stopper member
18 2^{nd} stopper member
19 Hole (in stopper member)
21 Annular space
22 Hole in granite stock
23 1^{st} adhesive
25 Silicone Adhesive
26 Filler
49 Granite stock
50 Select Raw Granite
52 Bore hole
53 Cute granite stock to length
54 Insert brass tube stock into hole
55 Insert brass tube into 1^{st} stopper
56 Insert 1^{st} stopper into hole
57 Pour 1^{st} adhesive
58 Cure 1^{st} adhesive
59 Turn down on lathe
60 Cute brass tubing
61 Apply silicone
62 Counterbore
63 Place filler inside counterbore
64 Grasp brass tube in lathe
90 Insert second stopper
91 Insert chafing tube
110 Modified lure body

### DETAILED DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention pertains to a method of manufacturing fishing lures, and to fishing lure products that are made using that method.

According to the present invention a fishing lure (generally designated 100 in the Figures) comprises a lure body 10, preferably made from granite stone.

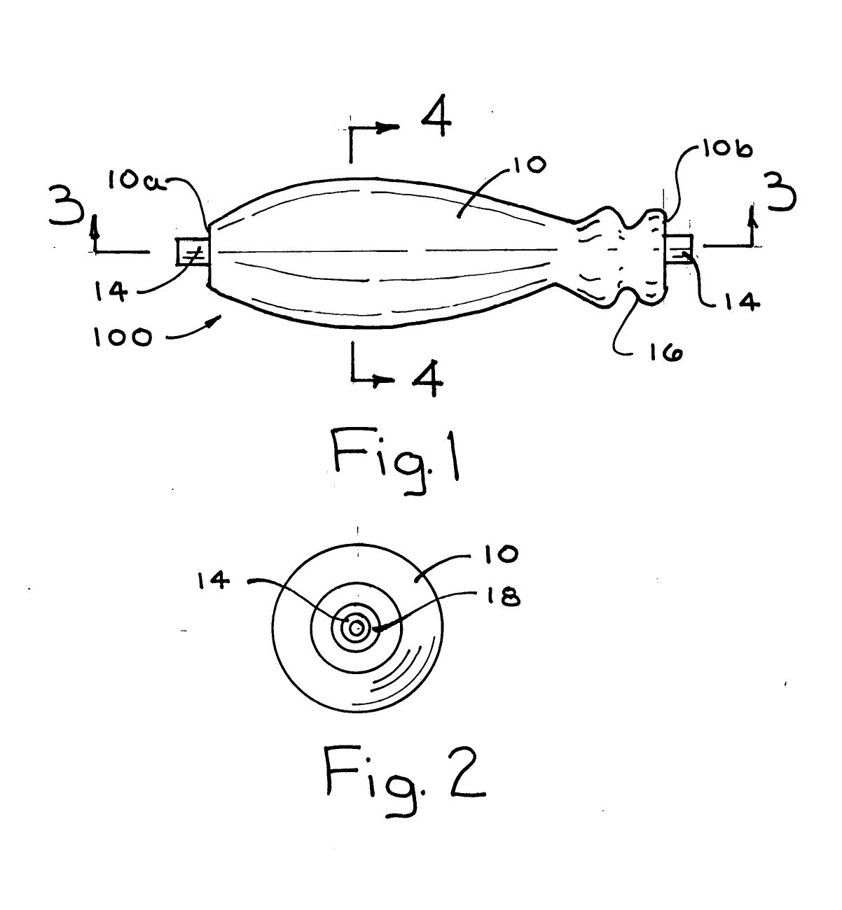

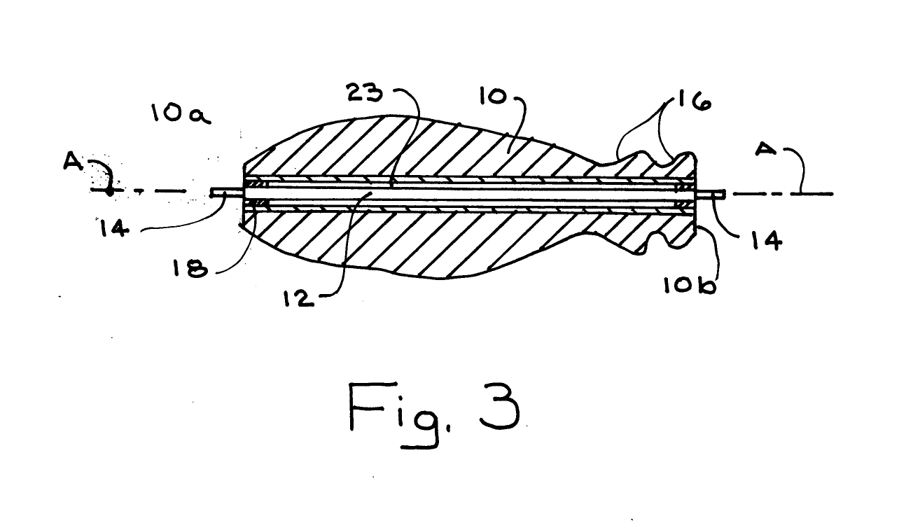

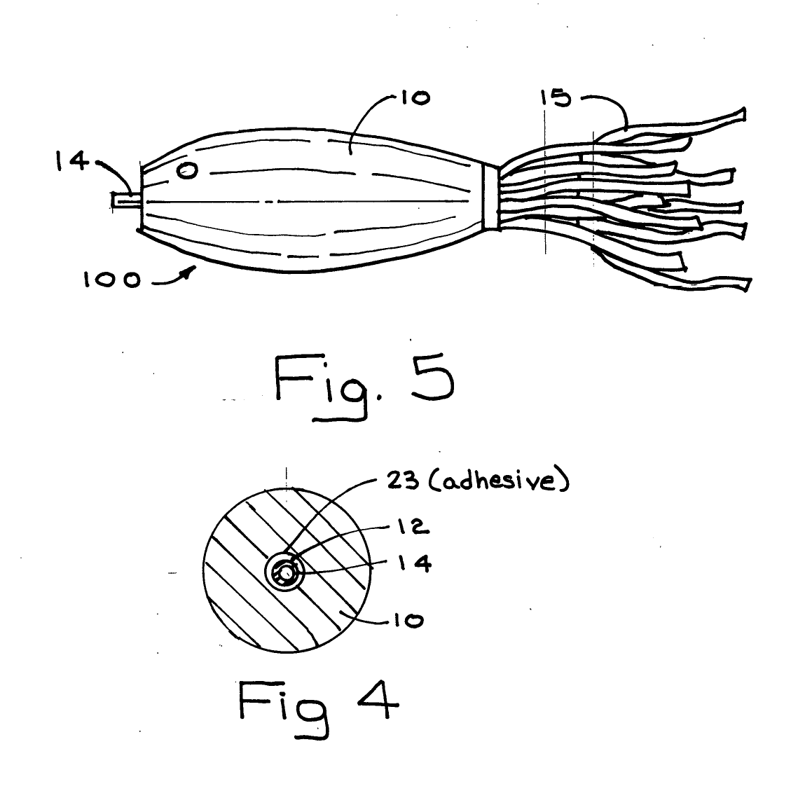

The lure body has a forward end 10a and a tail end 10b. The lure body 10 can be various shapes, sizes, colors, and weights, depending on the desired finished lure specifications and the species of fish that is to be caught using the lure. In a preferred embodiment of the invention, the lure body 10 is longitudinally symmetric such that it has a circular cross-section at all points along its longitudinal axis (A), as shown in FIGS. 1 and 4. The forward end 10a of the lure body is preferably tapered, such that is has a smaller cross-sectional diameter at its forward end than immediately rearward, so as to reduce hydrodynamic drag when the lure is pulled through water when in use. In modified embodiments, the lure body may have a non-circular cross-section. A shoulder 16 is provided near the tail end 10b of the lure body to facilitate attachment of a skirt 18, as shown in FIG. 5.

In a fishing lure constructed in accordance with the method of the present invention, a hollow chafing tube 14 disposed inside of a straight hollow brass tube 12, extends through the lure body 10 along its longitudinal axis A. The brass tube 12 is affixed to the lure body 10 with a first adhesive 23. The chafing tube 14 is hollow so to receive a fishing line (not shown), which passes through the lure when in use. The chafing tube 14 is preferably held in place on the inside of the brass tube 12 with a dab of silicone adhesive (not shown).

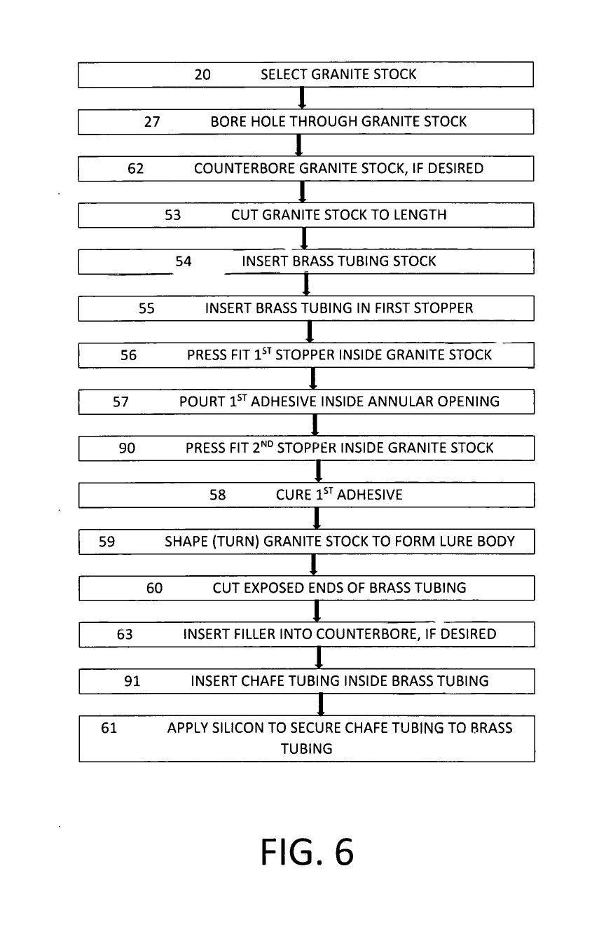

Referring now to FIG. 6, the preferred process of manufacturing a lure in accordance with the present invention is described below.

A granite stock 49 from which the lure body 10 is to be made is selected 20. In the preferred embodiment of the invention the lure body 10 is manufactured from a single piece of granite. However, as will be discussed in more detail further below, in modified embodiments of the invention the lure body can made of multiple pieces of granite adhered together.

A hole 22 is bored 52 through the granite stock 49.

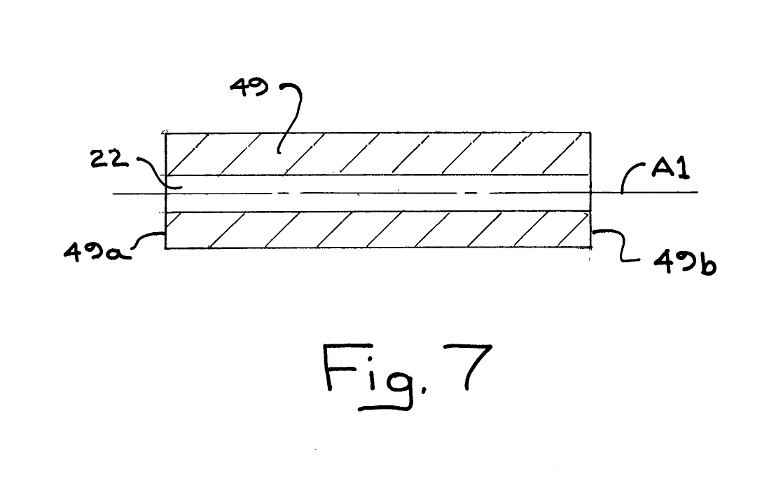

In the preferred embodiment of the invention, hole 22 is centered on the longitudinal axis (A1) of the granite stock 49 as shown in FIG. 7.

The granite stock 49 is cut 53 to its desired length from a forward end 49a to a tail end 49b.

Once the granite stock 49 is cut 53 to the desired length, brass tubing stock 13, which is preferably longer than the length of the granite stock, is inserted 54 into hole 22, as shown in FIG. 8. In the preferred embodiment of the invention, a first portion 13a of the brass tubing stock extends beyond the forward end 49a of the granite stock, and a second portion 13b of the brass tubing stock extends beyond the tail end 49b of the granite stock.

The second portion 13b of the brass tubing stock is then inserted 55 through a hole 19 in a first stopper member 17. The first stopper member 17 is press-fitted 56 into the tail end 49b of the granite stock, as shown in FIG. 8. First stopper member 17 preferably has a circular cross-section, the diameter of which is nominally equal to or greater than the diameter of hole 22 at the tail end 49b of the granite stock. First stopper member 17 preferably comprises a hard rubber material that is adapted to be press-fitted into hole 22. In the preferred embodiment of the invention, the length of first stopper member 18, measured along its longitudinal axis, is at least ⅛″ long, thereby enabling the first stopper member 17 to hold the brass tubing stock 13 concentrically aligned within hole 22 so as to form a uniform annular space 21 between the outside of brass tubing stock 12a and the granite stock 49 along the length of the brass tubing stock 12a inside of the granite stock 49.

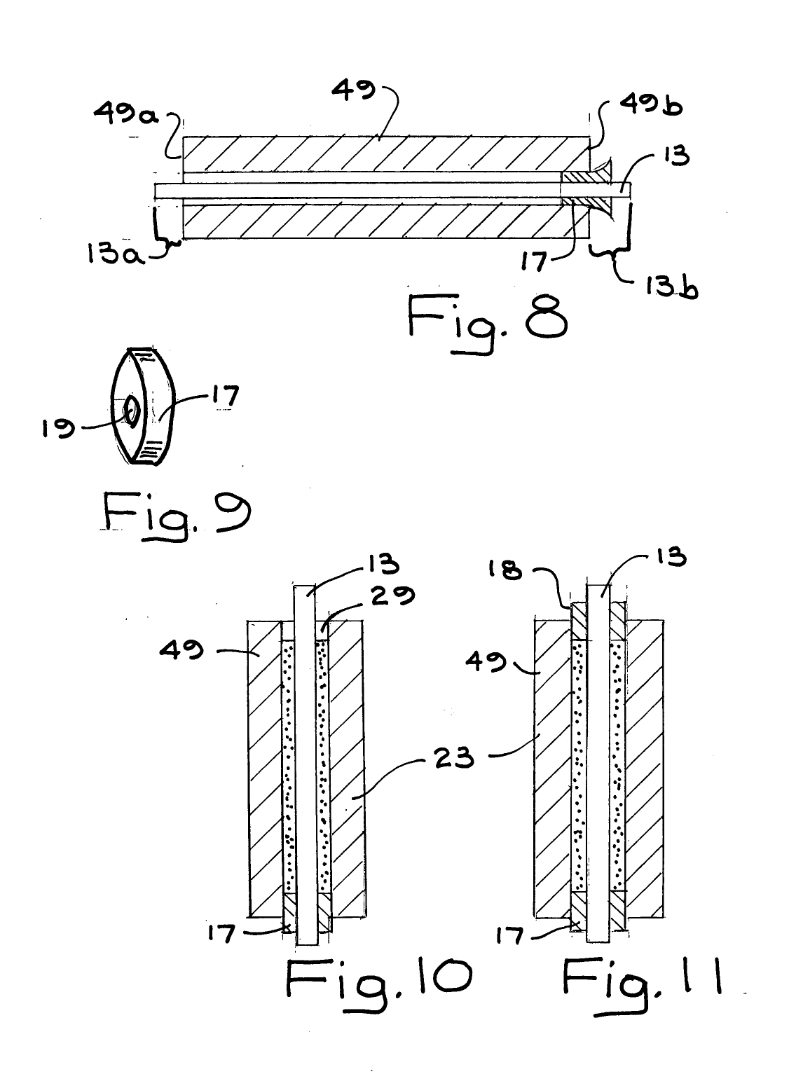

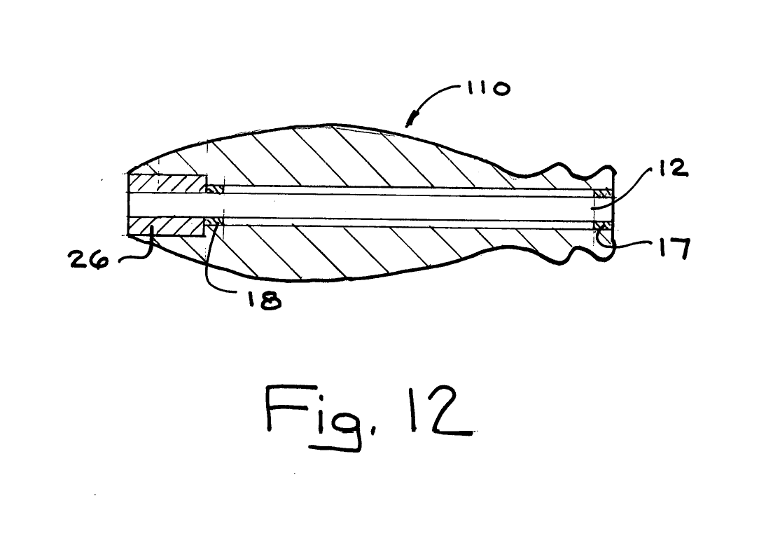

In the preferred embodiment of the invention the granite stock 49 is then temporarily supported in an upright orientation such that the first stopper member 17 is at the lower end, and a first adhesive 23 is poured 57 into the annular space 21 between the brass tubing stock 13 and the granite stock 49, as shown in FIG. 9. After the first adhesive 23 is poured into the annular space 21, a second stopper member 18 is press fitted 90 into the other end, thereby ensuring that the brass tubing 21 is centered in the hole and sealing the adhesive 23 in place while it hardens. The uncured adhesive 23 is preferably free flowing in order to ensure that the full length of the brass that is inside of the granite stock 49 is secured to the granite. The second stopper member 18 also preferably has a circular cross-section, the diameter of which is nominally equal to or greater than the diameter of hole 22 at the tail end 49b of the granite stock.

The first adhesive 23 is then cured 58, thereby firmly adhering the brass tubing stock 13 to the granite stock 49. In a preferred method of manufacturing a lure, the outside surface of the brass tubing stock is 13 scored, such as with grooves made by a pipe cutter, in order to enhance bonding of the first adhesive 23 to the brass tubing stock 13.

Brass tubing is used for the finished fishing lure 10 in order for the fishing line to be placed in the correct position to cause the lure to swim properly in the water. Brass is also advantageous for the finished fishing lure 10 as a guide for the chafing tubing 14 as well as to center the chafing tubing 14, again to make sure the lure swims correctly through the water when in use. It is important to have brass tubing because it is a material that will last through long term exposure to sea water where chafe tubing may need to be replaced. The brass makes it possible for chafe tubing to be replaced when needed due to normal wear and tear or if a different sized chafe tubing is desired. This would be difficult, if not be possible, if, for example, the chafe tubing 14 were adhered to the stone itself.

The granite stock 49 is preferably shaped 59 on a lathe, so as to produce the lure body 10, using a diamond embedded circular blade using a duplicator or CNC to mimic a predetermined lure shape/style. The ends 13a and 13b of the brass tubing stock, which during manufacture protrude from beyond opposite ends of granite stock 49, can be temporarily and advantageously secured to a lathe during the process of shaping 59 the lure body on the lathe.

Once it is cut to the correct size the granite lure body 10 can be soaked in die if a specific color is wanted, or, alternatively, it can be left with the natural color. The lure body 10 is then polished on the lathe. Once polished, the head of the lure is cut to the desired style/angle and polished. Then two small holes may be bored into the surface of the lure body for “eyes” to be adhered to the lure body 10, if eyes are desired on the lure. The lure body 10 can then be treated with a granite polish or impregnator to enhance its shine if desired.

After the lure body 10 has been shaped on the lathe, the exposed ends 13a and 13b of the brass tubing stock may be cut 60 off flush with the respective ends 10a and 10b of the lure body.

Chafe tubing 14, preferably comprising a pliable plastic material, is inserted 91 into the brass tubing 12 and secured 61 in place with a dab of silicone adhesive (not shown). When in use, the chafe tubing 12 prevents the fishing line from being cut by the lure body 10 or by the brass tubing 12.

A replaceable skirt (or skirts) may slid onto the shoulder 16 (or shoulders) at the tail end 10a of the lure body.

The final product 100 is used just like other common fishing lures. It will be appreciated by those skilled in the art that the granite material of the lure body makes the fishing lure nearly indestructible, and it will almost never scratch nor lose its natural shine. Granite is also porous and can be soaked in fish attractant to make it more effective in hunting fish. Any kind of colored die to change the color of the stone may be used. Some granite can be very shiny when in natural light. This makes it more attractive to fish because it looks more natural than the average fishing lure.

In the preferred embodiment of the invention, the granite stock member 49 comprises a single natural piece of granite. In a modified embodiment of the present invention, the granite stock member 49 may be comprise multiple pieces of granite of equal or different lengths arranged longitudinally along axis A1 and adhered to each other so as to form a single granite stock member of virtually any desired size. In another modification of the present invention, the granite stock member 49 may comprise a pair of granite pieces arranged laterally on opposite sides of axis A1 and adhered to each other so as to form a single granite stock member 49. The cut pieces can be adhered to each other if a multi-colored lure is desired, or if a larger lure is needed, or if a colored lateral line is desired to help attract a fish. A lateral line can be created, if desired, by coloring the adhesive used to adhere the granite together.

Many other modifications and other embodiments of the invention will come to mind to one skilled in the art to which this invention pertains having the benefit of the teachings presented in the foregoing descriptions and the associated drawings. For example:

As described above, in the preferred embodiment of the invention hole 22 is bored through the granite stock member 49 prior to shaping the lure body. However, in a modified embodiment of the invention, the hole 22 can be bored in the lure body 10 after shaping the lure on the lathe. A reason for drilling this hole after shaping the lure on the lathe is that it helps in drilling the hole where it will make the lure swim properly depending on what swimming action is desired.

Whereas in the preferred embodiment of the invention diameter of hole 22 (and, therefore, the annular space 21 between the brass tube 12 and the lure body 10) is uniform from the head end 10a to the tail end 10b of the lure body, in a modified embodiment of the invention, at least one end of the lure body 10 is counterbored, as shown in FIG. 11. A filler material 26 is placed 63 inside of, and adhered to, the inside of the counterbored space between the brass tube 13 and the granite stock 49. The filler material may be plastic resin or other material so as to change the center of mass of the fishing lure, and thereby change the manner in which the lure swims through the water when in use.

Whereas in the preferred embodiment of the invention, a single lure body is turned down (59) on a lathe and cut (60) from a single piece of granite stock 49, in a modified embodiment of the invention several lure bodies can be shaped in a continuous lathe operation from a single piece of granite stock, and subsequently cut apart after all of the lure bodies have been turned on the lathe.

Whereas in the preferred embodiment of the invention the lure body 10 has a circular cross-section throughout its length, in a modified embodiment of the invention the lure body have other than a circular cross-section. In such modifications of the present invention, the lure body may be shaped by a lathe or by casting or molding.

Whereas in the preferred embodiment of the invention the axis of hole 22 and the longitudinal axis of the lure body are congruent, in a modified embodiment of the invention the axis of a through hole (and brass tube) may be parallel to or at an angle to the longitudinal axis of the body of the lure, so as to advantageously change the manner in which the lure swims through water when in use.

Whereas in the preferred embodiment of the invention the brass tubing is adhered to the granite stock before the lure body has been shaped (i.e., turned) on a lathe, in a modified embodiment of the invention a brass tube is adhered to the lure body after it has been shaped.

Whereas in the preferred embodiment of the invention the first 17 and second stopper 18 members comprises a hard rubber material, in modified embodiments of the invention materials other than hard rubber may be used.

Whereas in the preferred embodiment of the invention the opposite ends 13a, 13b) of the brass tubing stock 13 protrude from the ends of the granite stock 49 during manufacture of the lure, in a modified method of manufacturing a fishing lure, the brass tubing stock 13 may extend only beyond one end (49a or 49b) of the granite stock 13, in which embodiment the jaws of a lathe would grasp 64 that one protruding end of the brass tubing stock 13, or onto the stone, itself, during manufacture.

Whereas in the preferred embodiment of the invention, the lure body is constructed of granite material, in modified embodiments of the invention the lure body may be constructed of different natural stone material.

Whereas in the preferred embodiment of the invention, the opposite ends of brass tube 12 are flush with the respective ends (10a, 10b) of the lure body, in a modified embodiment of the invention at least one end of the brass tube is cut off a finite distance from (i.e., outboard of) the end of the lure body, thereby preventing the chafing tube from wearing against the granite lure body.

Whereas in the preferred embodiment of the invention, the opposite ends of chafing tube 14 are flush with the respective ends of the brass tube 12, in a modified embodiment of the invention at least one end of the chafing tube 14 extends a finite distance from (i.e., outboard of) the end of the brass tube 12, thereby facilitating removal and replacement of the chafing tube.

A noise-maker, such as a rattle or vibrator, to attract fish when the lure is in use, may be disposed inside of the counterbore inside of the lure body.

Therefore, it is to be understood that the invention is not to be limited to the specific embodiments disclosed and that modifications and other embodiments are intended to be included within the scope of the appended claims.

I claim:

1. A method of manufacturing a fishing lure comprising the steps of:
selecting a granite member having a first end and a second end;
boring a hole through said granite member from said first end to said second end of said granite member, wherein said hole has a first hole diameter;
inserting a straight brass tube in said hole so as to create a first annular space between and outside surface of said brass tube and said granite member, wherein said brass tubing has a first length that is greater than the distance between said first end and said second end of said granite member, and wherein said brass tubing has an outside diameter that is smaller than said first hole diameter, and wherein a first portion of said brass tube extends beyond said first end of said granite member;
placing a first elastomeric stopper member in said hole at said first end of said granite member, wherein said first stopper member has an outside diameter, and wherein said first stopper member has a first stopper through hole that is concentric with said outside diameter of said first stopper member;
inserting a portion of said brass tube into said first stopper member through hole;
pouring a curable liquid first adhesive into said to said first annular space;
placing a second elastomeric stopper member in said hole at said second end of said granite member, wherein said second stopper member has an outside diameter, and
wherein said second stopper member has a second stopper through hole that is concentric with said outside diameter of said second stopper member;
inserting a portion of said brass tube into said second stopper member through hole;
curing said first adhesive so as to affix said straight brass tube to said granite member;
inserting a pliable hollow tube member inside of said brass tube member;
and, applying a second adhesive to an outer surface said pliable hollow tube member to secure said pliable hollow tube member to said brass tube member.

2. The method according to claim 1, and further comprising the step of:
cutting at least a portion of an outside surface of said granite member into a circular shape, said circular shape having a central axis, and wherein said central axis is congruent with a longitudinal axis of said brass tube member.

3. The method according to claim 2, further comprising:
grasping said first portion of said brass tube member in a lathe,
and wherein said step of cutting at least a portion of said outside surface of said granite member into a circular shape comprises turning said granite member in said lathe.

4. The method according to claim 3, further comprising:
after said step of turning said granite member, shortening the length of said brass tube member by cutting said brass tube member.

5. The method according to claim 4, further comprising:
cutting a shoulder into said granite member, and
attaching a removeable skirt to said shoulder.
